(19) United States
(12) Patent Application Publication
(10) Pub. No.: US 2008/0018060 A1
(43) Pub. Date: Jan. 24, 2008

(54) Chuck

(76) Inventors: Masato Ishii, Nara-ken (JP); Yoshitomo Ishii, Nara-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/822,824

(22) Filed: Jul. 10, 2007

(30) Foreign Application Priority Data
Jul. 20, 2006 (JP) 2006-198807

(51) Int. Cl. B23B 31/16; B23B 31/30

(52) U.S. Cl. 279/4.06

(57) ABSTRACT

An object of the present invention is to prevent the floating-up of a gripped workpiece, and to prevent the gripping from weakening due to centrifugal force accompanying fast rotation. A configuration is employed in which a chuck of the present invention includes master jaws each having a gripping claw and fitted into recessed grooves provided on a plurality of radial lines in a front surface of a rotating body that rotates together with a spindle so as to slide within a range between grasping and grasping release, pistons provided so as to slide forward and backward by fluid pressure applied behind the master jaws inside of the above-mentioned rotating body, an interlocking unit provided so as to slide the above-mentioned master jaws in a grasping direction and in a grasping release direction by the sliding of the pistons, weights incorporated behind the respective master jaws of the above-mentioned rotating body so as to slide in a central direction and in a circumferential direction of the above-mentioned rotating body and is given pressing force in the circumferential direction, and levers each provided so that a distance between an intermediate supporting point and one end engaging with each of the above-mentioned weights is larger than a distance between the intermediate supporting point and another end engaging with each of the above-mentioned master jaws.

### BACKGROUND OF THE INVENTION

(1) Field of the Invention

The present invention relates to a chuck that prevents a workpiece from floating up by gripping the workpiece, and prevents gripping force to the workpiece from weakening due to centrifugal force acting with fast rotation.

(2) Description of the Related Art

A decrease in working accuracy due to floating up in gripping the workpiece causes a defective to occur, and gripping force of the workpiece weakens due to centrifugal force acting on master jaws and top jaws with the fast rotation of a chuck, so that with the weakening gripping force, an adverse effect on the working accuracy is brought about, and the workpiece jumps out due to slip or the like, which causes an accident.

Consequently, there has been a chuck adapted to prevent weakening of the gripping force by the centrifugal force occurring with fast rotation of the chuck (Japanese Examined Utility Model Application Publication No. 56-10483).

### SUMMARY OF THE INVENTION

In the chuck having the structure of Japanese Examined Utility Model Application Publication No. 56-10483, a lever having a supporting point at a midpoint, which is a bisected position, is swung by a weight moving circumferentially by centrifugal force accompanying the rotation of a body, and a workpiece is grasped by top jaws each integral with a master jaw while forcibly sliding the master jaw in a central direction of the body through this swung lever. Namely, weakening of the grasping force is resolved by the weight.

According to this method, since the supporting point of the lever engaging with the weight and the master jaw at both ends thereof is at the midpoint, which is the bisected position, a large difference between centrifugal force of the weight and combined centrifugal force of the master jaw and the top jaw is caused, thereby decreasing the gripping force. Namely, difficulty in equalizing a weight of the weight and a weight of the master jaw and the top jaw results in a decrease in the gripping force.

When the centrifugal force on the jaw side largely increases by the fast rotation, in the application of cutting force to the workpiece with the machining, not so strong grasping force allows the workpiece to jump out from the gripping portion, which leads to an accident.

Moreover, since there is no drawing-in mechanism for the workpiece, the floating-up of the workpiece occurs together with the gripping force when it is gripped, which makes the chuck unsuitable for high-accuracy machining and fast rotation.

Furthermore, since a slide portion of the master jaw is exposed on a surface of the body, coolant liquid and cutting debris enter, thereby disturbing smooth sliding of the master jaw.

This has posed a problem in that maintenance needs to be frequently conducted.

Consequently, an object of the present invention is to provide a chuck adapted to resolve the above-described problems.

In order to solve the above-described problems, the present invention employs a configuration in which a chuck includes recessed grooves provided on a plurality of radial lines in a front surface of a rotating body that rotates together with a spindle, master jaws each having a gripping claw and fitted into each of the recessed grooves so as to slide within a range between grasping and grasping release, a moving-forward and backward unit provided so as to slide forward and backward by fluid pressure applied behind each of the master jaws inside of the above-mentioned rotating body, an interlocking unit provided so as to slide the above-mentioned master jaws in a grasping direction and in a grasping release direction by the sliding of this moving-forward and backward unit, weights incorporated behind the respective master jaws of the above-mentioned rotating body so as to slide in a central direction and in a circumferential direction of the above-mentioned rotating body and is given pressing force in the circumferential direction, and levers each provided so that a distance between an intermediate supporting point and one end engaging with each of the above-mentioned weights is larger than a distance between the intermediate supporting point and another end engaging with each of the above-mentioned master jaws.

By making the distance from the supporting point of the lever to the other end engaging with the master jaw smaller than the distance from the supporting point of the lever to the one end engaging with the weight, centrifugal force of the weight is doubled to be applied to the master jaw.

Therefore, the centrifugal force can be applied effectively without being offset, and weakening of grasping force can be eliminated.

Additionally, a gripped workpiece can be drawn in together with the master jaws.

Moreover, a configuration is employed in which the slide recessed grooves for the master jaws are provided in a disc incorporated into a hollow portion inside of the rotating body so as to rotate together with the above-mentioned rotating body, and an O ring for sealing is interposed in a circumferential surface of the disc closing the above-mentioned hollow portion, long holes are each provided in a position on the above-mentioned disc opposed to each of the above-mentioned master jaws, and attachment seats and gripping claws are attached to master jaw front portions penetrating these long holes.

Consequently, the smooth sliding of the master jaws are ensured, and maintenance is not required.

Furthermore, a configuration is employed in which the recessed grooves are formed in a disc fitted into a hollow portion of the rotating body, this disc is given protruding force that protrudes the disc forward by a spring, and limiting collars to a protruding amount by the protruding force given to the above-mentioned disc are fitted in bolts screwed in the above-mentioned disc from a back wall of the above-mentioned hollow portion.

Consequently, the centrifugal force of the weights is doubled and applied to the master jaws, and the gripped (grasped) workpiece is drawn in together with the master jaws, so that this drawing-in allows the disc having the gripping claws to be drawn back by fluid continuously supplied to the moving-forward and backward unit against the protruding force.

This action of drawing-back further increases the drawing-in after drawing-in of the workpiece as described above.

As described above, according to the chuck of the present invention, since a weight of the weight by the centrifugal force occurring with the rotation of the rotating body is doubled by the lever to be applied to the master jaw side, the weakening of the gripping force is not caused, that is, the centrifugal force on the gripping side can be effectively applied by the centrifugal force of the weight without being offset, thereby eliminating a decrease in gripping force, the chuck can address the fast rotation, and can also prevent an accident from occurring.

Thus, the stable gripping force of the workpiece can be obtained, and the centrifugal force to the master jaws can be applied in the grasping direction immediately after rotation start of the rotating body by the pressing force in the outer circumferential direction of the rotating body, which has been given to the respective weights.

Moreover, since the master jaws are drawn in by the fluid applied during machining, and this drawing-in allows the workpiece to be drawn in, the workpiece does not jump out, which enables high-accuracy machining.

Furthermore, since the slide recessed grooves for the master jaws are provided inside of the rotating body, neither coolant liquid nor cutting debris enters.

This can make the maintenance taking a lot of time and effort unnecessary and ensure the smooth sliding of the master jaws.

### BRIEF DESCRIPTION OF THE DRAWINGS

FIG. 1 is a front view showing an embodiment of the present invention;

FIG. 2 is a vertical cross-sectional front view showing the same;

FIG. 3 shows a vertical cross-sectional side view;

FIG. 4 is a vertical cross-sectional front view showing a section of weights;

FIG. 5 is a vertical cross-sectional side view showing a fluid supplying passage;

FIG. 6 is an exploded perspective view showing a substantial part of the same;

FIG. 7 is a vertical cross-sectional enlarged side view showing the action of a lever; and

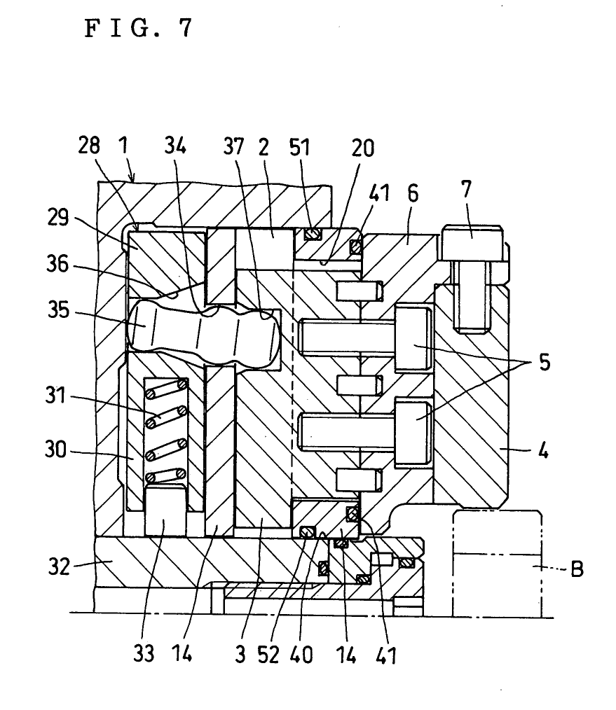

FIG. 8 shows a vertical cross-sectional side view of another example that slides a piston.

### DESCRIPTION OF THE PREFERRED EMBODIMENTS

Hereinafter, embodiments of the present invention are described based on accompanying drawings.

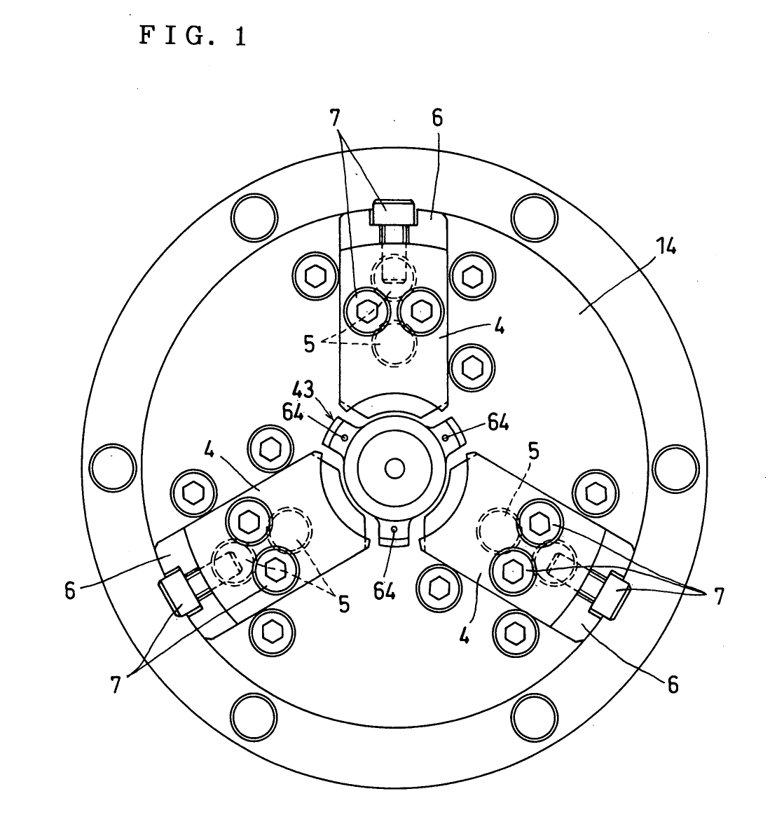

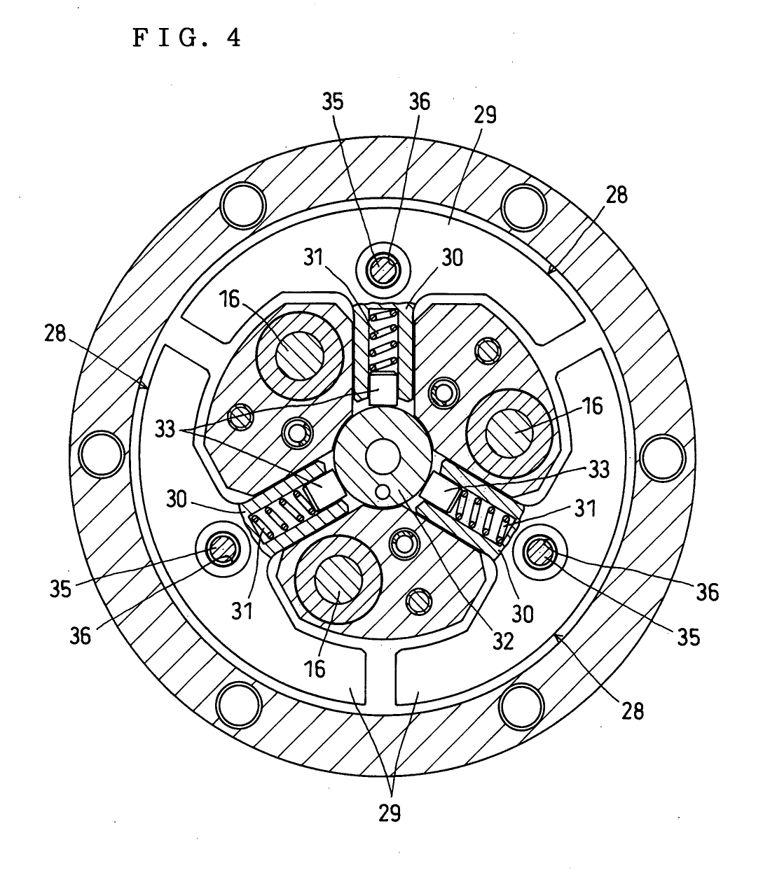

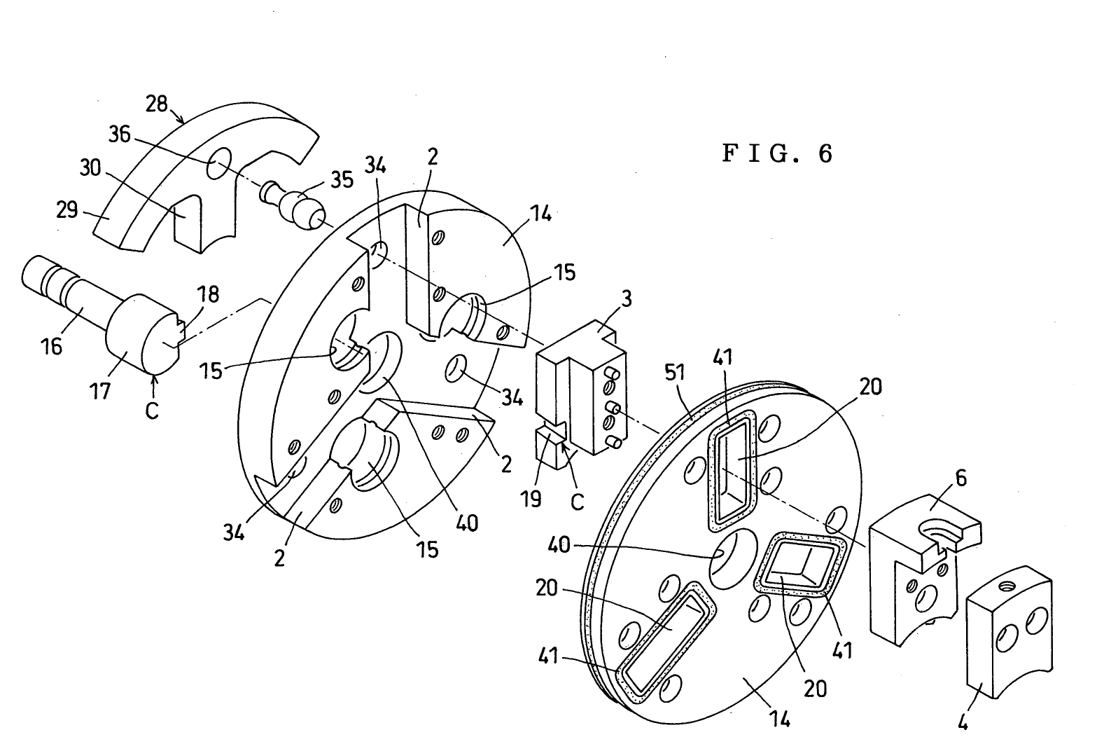

In a first embodiment of the present invention, as shown in FIGS. 1 through 6, there are provided recessed grooves 2 opening a front surface on a plurality of radial lines in the front surface of a rotating body 1 that rotates together with a spindle A of a machine tool, and master jaws 3 each having a gripping claw 4, which slide within a range between grasping and grasping release, are fitted into these respective recessed grooves 2.

The above-mentioned gripping claw 4 is exchangeably attached through bolts 7 to an attachment seat 6, which is attached to a front surface of the master jaw 3 through bolts 5 in the illustrated case.

Moreover, behind the master jaw 3 inside of the rotating body 1, a moving-forward and backward unit slid forward and backward by applied fluid pressure.

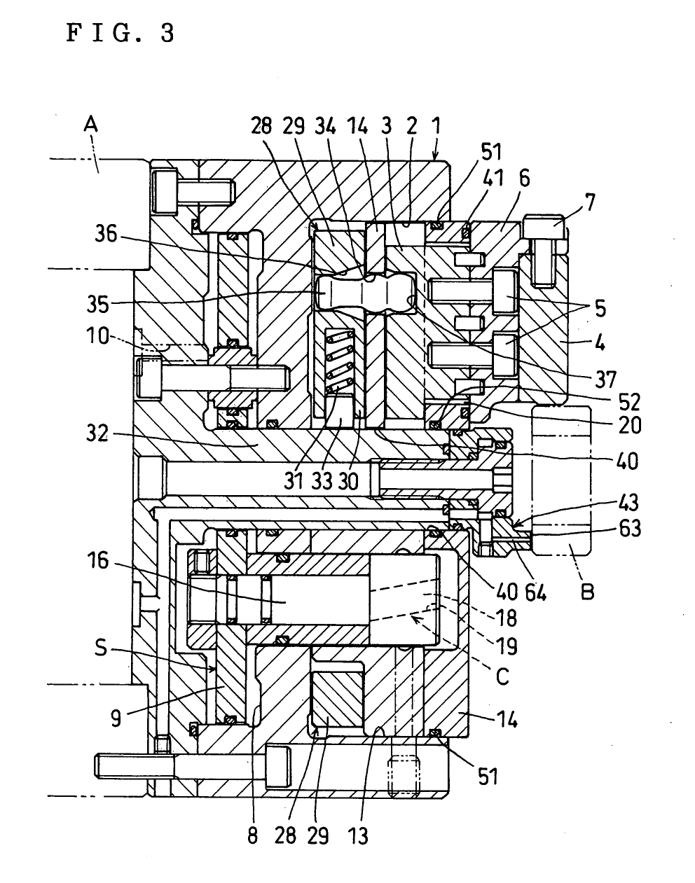

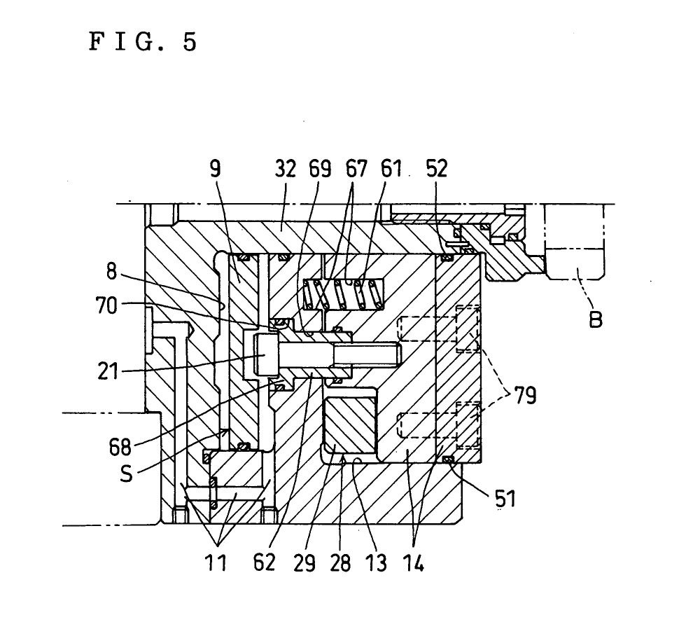

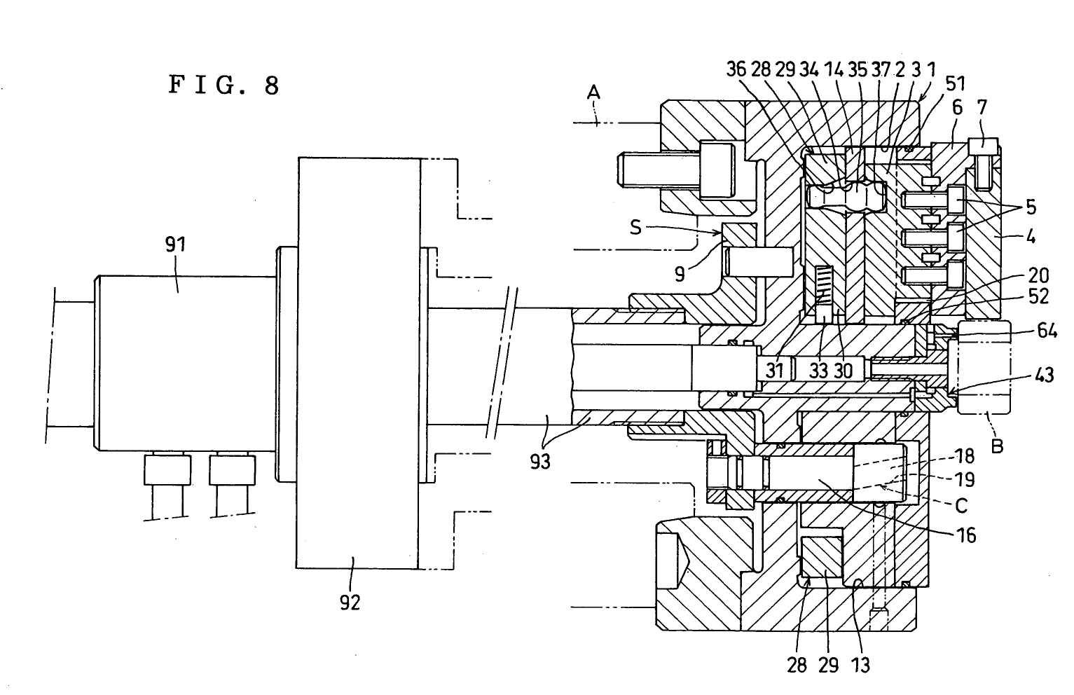

With the above-mentioned moving-forward and backward unit S, as shown in FIG. 3, a hollow chamber 8 is provided at the rear of the rotating body 1, and a piston 9 is incorporated in this hollow chamber 8 as the moving-forward and backward unit S. In the moving-forward of the piston 9, the fluid pressure supplied from a first passage 10 is applied to a back surface of the piston 9 in the hollow chamber 8 as shown in FIG. 3, while in the moving-backward of the piston 9, the fluid pressure supplied from a second passage 11 is applied to a front surface of the piston 9 in the hollow chamber 8 as shown in FIG. 5. However, the configuration is not limited to this, but for example, as shown in FIG. 8, a flange (coupled to a rod 16 of an interlocking unit C described later) as the piston 9 may be provided at a tip end of a draw tube 93 moving forward and backward by fluid pressure applied to a cylinder 92 from a journal 91 as the moving-forward and backward unit S.

In some cases, a tube journal (illustration is omitted) that forcibly feeds air to a coolant tube may be arranged behind the journal 91.

Furthermore, with sliding of the piston 9, the master jaw 3 is forcibly slid by the interlocking unit C between a grasping direction and a grasping release direction, and a workpiece B is drawn in at the time of grasping.

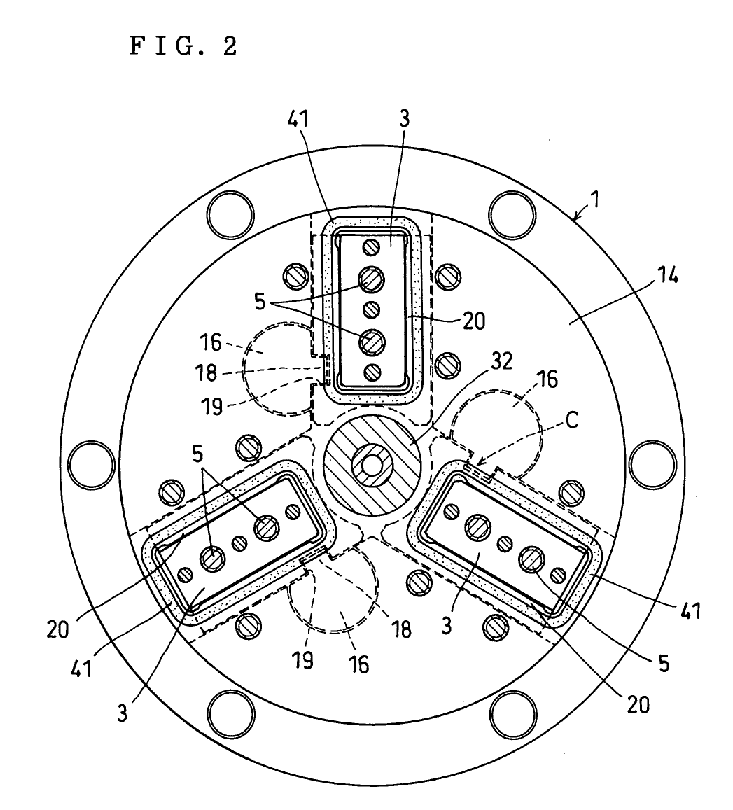

The above-mentioned interlocking unit C is configured such that as shown in FIGS. 2, 3, and 6, the same number of penetrating holes 15 as those of the master jaws 3 are provided in a disc 14, which is incorporated into the hollow portion 13 oriented inward from the front surface of the rotating body 1, and is bound by bolt 79 stopping not to rotate, and tip expanded portions 17 of rods 16, in each of which a terminal is bolted on the piston 9 not to rotate, are fitted into these penetrating holes 15, and that a protrusion 18 of each of the expanded portions 17, which is provided in an outer circumference of the expanded portion 17 so as to obliquely cross with respect to an axis of the above-mentioned rod 16, is fitted into a groove 19 in an engaging manner, which is provided in a side surface so as to obliquely cross with respect to a sliding direction of the master jaw 3 (at the same angle as that of the protrusion 18).

Consequently, the master jaws 3 slide in a central direction and in a circumferential direction with the sliding of the pistons 9 to draw in the workpiece B at the time of grasping.

Obviously, the sliding of the pistons 9 may be converted to the sliding of the master jaws 3 in a perpendicular direction by another mechanism.

With the disc 14, two front and back discs make a pair, and both rear sides of each of the master jaws 3 are fitted into the radial recessed groove 2 provided in a front surface of the rear disc 14 for guiding, and a front portion of the master jaw 3 penetrates a long rectangular hole 20 of the front disc 14 (in the radial direction and slidably within a range in the grasping direction and in the grasping release direction), and the two discs 14 making a pair are integrated by bolts 21 to slidably embrace the master jaws 3 by the front and rear discs 14, 14.

Moreover, behind the master jaws 3 inside of the hollow portion 13, weights 28 that slide in the central direction of the rotating body 1 and in the circumferential direction thereof are provided so as to face the respective master jaws 3.

Each of the above-mentioned weights 28 is composed of an arcuate portion 29 and a cylindrical leg portion 30 projected from the center between both ends of this arcuate portion 29 in the central direction, and a spring 31 inserted into the leg portion 30 has one end abutting against a bottom of the leg portion 30 and the other end abutting, through a slide pin 33, against an outer circumferential surface of shafting 32 oriented to the front surface of the rotating body 1 via the inside of the hollow portion 13, at the center of the rotating body 1 so as to gives the weight 28 protruding force oriented in the circumferential direction of the rotating body 1.

Consequently, the weight 28 instantly slides in the circumferential direction of the rotating body 1 by the centrifugal force with the rotation of the rotating body 1.

Furthermore, a through-hole 34 for a supporting point is provided in a position on the rear disc 14 opposed to each of the master jaws 3, and one end of a lever 35 penetrating this through-hole 34 is fitted into an engagement hole 36 at the center between both the ends of the arcuate portion 29 of the weight 28, while the other end of the lever 35 is fitted into an engagement hole 37 at the center of the master jaw 3.

At this time, a distance from the supporting point (through-hole 34) of the lever 35 to the one end on the weight 28 side is made larger than a distance from the supporting point (through-hole 34) of the lever 35 to the other end on the master jaw 3 side (the ratio shown in the figure is 2:1), and this ratio allows the centrifugal force of the weight 28 to be doubled and applied to the master jaw 3.

Reference numeral 40 in the figure denotes a penetrating hole of the shafting 32 provided at the center of the disc 14, reference numeral 41 denotes an O ring arranged along an edge of the long hole 20 on the front surface of the front disc 14, which prevents coolant liquid and cutting debris from entering from a lapping surface of the master jaw 3 and the attachment seat 6. Reference numeral 43 denotes a seating stopper of the workpiece B, which has a seating surface 63 positioned in a longitudinal direction of the workpiece B, and a sensor bore 64 for seating detection.

The above-described configuration allows the workpiece B to be fitted between internal ends of the gripping claws 4.

Next, when the fluid is supplied to the hollow chamber 8 from the second passage 11 to move the piston 9 backward and make the rod 16 travel backward, the respective master jaws 3 are slid in the central direction through the interlocking unit C to grip the workpiece B by the gripping claws 4. Furthermore, the fluid continues to be constantly supplied to the hollow chamber 8 to keep the piston 9 traveling backward, until the disc 14, the attachment seats 6 and the gripping claws 4 become integral to be drawn in at a certain amount (be moved to the left). Consequently, the gripped workpiece B is stabilized by making close contact with the seating surfaces 63, which prevents the floating-up of the workpiece B.

On the other hand, the weights 28 are slid in the circumferential direction by the centrifugal force occurring with the rotation of the rotating body 1.

Force (moment) that slides the respective master jaws 3 in the central direction acts on the master jaws 3 by inclination of the levers 35 with sliding of the weights 28.

With this acting force, since the distance between the supporting point of the lever 35 to the one end engaging with the weight 28 is made longer than the distance between the supporting point of the lever 35 to the other end engaging with the master jaw 3, the centrifugal force of the weight 28 is doubled to act on the master jaw 3.

This allows the machining to be performed while maintaining the gripping force having strong drawing-in without weakening of the gripping force of the gripping claw 4 (without any effect by the centrifugal force acting on the master jaw 3, the attachment seat 6 and the gripping claw 4).

Moreover, since even during machining, the supply of the fluid from the second passage 11 is continued, the drawing-in of the workpiece B by the disc 14, the master jaws, 3, the attachment seats 6, and the gripping claws 4 is performed, which, at high accuracy, prevents the workpiece B from jumping out.

According to a second embodiment of the present invention, the slide recessed grooves 2 for the master jaws 3 are provided inside of the rotating body 1.

A reason of the above-described provision of the recessed grooves 2 inside of the rotating body 1 is to prevent the coolant liquid used during machining, cutting debris and the like from entering the inside of the recessed groove 2 to hinder the smooth sliding of the respective master jaws 3, and to require frequent maintenance.

Therefore, an O ring 51 is interposed in an outer circumference of the front disc 14 fitted into the hollow portion 13 in the front surface of the rotating body 1, and an O ring 52 is interposed in an inner circumference of the disc 14.

The long hole 20 in the sliding range of each of the master jaws 3 is provided in the position of the front disc 14 opposed to each of the master jaws 3, the front portion of the master jaw 3 slidably penetrates this long hole 20, and the gripping claw 4 is attached to the penetrating front surface of the master jaw 3 with the attachment seat 6 interposed.

An O ring 41 to come into contact with a back surface of the attachment seat 6 is arranged along an edge of the long hole 20.

According to a third embodiment of the present invention, as shown in FIG. 5, protruding force that protrudes the incorporated disc 14 slightly forward is given to the disc 41 by a spring 61.

The above-mentioned spring 61 is fitted into a recessed portion 67 provided in an opposed surface between a back wall of the hollow portion 13 and the disc 14.

A collar 62 is fitted into each of the bolts 21 which bind the disc 14 not to rotationally move and are screwed in the disc 14 from the back wall of the hollow portion 13, and a terminal vamplate portion 68 of this collar 62 is fitted into a diameter-expanded recessed step portion 70 having a large diameter on the insertion end side of a penetrating hole 69 for the collar 62, which is provided in the back wall of the hollow portion 13 to limit a protrusion amount of protruding force given by the spring 61 to a certain level and to permit the disc 14 to slide in certain amount of sliding to the back wall side of the hollow portion 13.

Consequently, the centrifugal force of the weights 28 is doubled by the levers 35 and applied to the master jaws 3 to grasp the workpiece B. Following this action, the disc 14 having the gripping claws 4 is drawn back against the protruding force by the spring 61 by the fluid continuing to be applied to the pistons 9, so that the workpiece B is further drawn in until it comes into close contact with the seating surfaces 63 while being grasped.

This action of the drawing-back increases the function such that after the grasped workpiece B is grasped in as described above, the workpiece B is further drawn in, which prevents the floating-up or jumping-out of the workpiece B. This enables high-accuracy machining and machining under fast operation (rotation).

What is claimed is:

1. A chuck comprising:
recessed grooves provided on a plurality of radial lines in a front surface of a rotating body that rotates together with a spindle;
master jaws each having a gripping claw and fitted into each of the recessed grooves so as to slide within a range between grasping and grasping release;
a moving-forward and backward unit provided so as to slide forward and backward by fluid pressure applied behind each of the master jaws inside of said rotating body;
an interlocking unit provided so as to slide said master jaws in a grasping direction and in a grasping release direction by the sliding of this moving-forward and backward unit;
weights incorporated behind the respective master jaws of said rotating body so as to slide in a central direction and in a circumferential direction of said rotating body and is given pressing force in the circumferential direction; and
levers each provided so that a distance between an intermediate supporting point and one end engaging with each of said weights is larger than a distance between the intermediate supporting point and another end engaging with each of said master jaws.

2. The chuck according to claim 1, wherein the slide recessed grooves for the master jaws are provided in a disc incorporated into a hollow portion inside of the rotating body so as to rotate together with said rotating body, and an O ring for sealing is interposed in a circumferential surface of the disc closing said hollow portion, long holes are each provided in a position on said disc opposed to each of said master jaws, and attachment seats and gripping claws are attached to master jaw front portions penetrating these long holes.

3. The chuck according to claim 1, wherein said recessed grooves are formed in a disc fitted into a hollow portion of the rotating body, this disc is given protruding force that protrudes the disc forward by a spring, and limiting collars to a protruding amount by the protruding force given to said disc are fitted in bolts screwed in said disc from a back wall of said hollow portion.
